(19) United States
(12) Patent Application Publication
(10) Pub. No.: US 2015/0213457 A1
(43) Pub. Date: Jul. 30, 2015

(54) SYSTEM AND METHODS FOR PRICING A COMMODITY

(71) Applicant: Thales Energy, Inc., Albuquerque, NM (US)

(72) Inventors: Jason LIBERSKY, Albuquerque, NM (US); Daniel Klein, Santa Fe, NM (US); Joe Merlino, Santa Fe, NM (US); John Melby, San Diego, CA (US)

(73) Assignee: Thales Energy, Inc., Albuquerque, NM (US)

(21) Appl. No.: 14/165,075

(22) Filed: Jan. 27, 2014

(51) Int. Cl. G06Q 30/00; E21B 41/00; G06Q 40/00

(52) U.S. Cl. CPC G06Q 30/018; G06Q 40/00; G06Q 40/04; E21B 41/0092

(57) ABSTRACT

A method for differentiating a commodity is provided. The method comprises establishing a predetermined set of protocols; establishing a standard for each protocol; collecting data from at least one user device; determining by one or more computing devices whether information regarding each of the protocols meets or exceeds an identified protocol compliance threshold; and identifying the commodity as a differentiated commodity when at least the plurality of the protocols meets or exceeds the identified protocol compliance threshold. The at least one user device is configured to send information regarding the protocols.

### TECHNICAL FIELD

The present invention generally relates to commodity pricing, and, in particular, to premium commodity pricing and differentiation based on compliance with a predetermined set of protocols.

### BACKGROUND

A commodity may be any one of many goods and services considered to be at least partially or completely fungible. In view of their generally fungible nature, the source or quality of a commodity may generally be considered to be equal and irrelevant to the commodity price at a commodity exchange.

Commodities are traded on various commodity and futures exchanges or markets. The broad categories of commodities traded on the various commodity exchanges are, for example, energy (crude oil, ethanol, natural gas, heating oil, gasoline, propane, purified terephthalic, etc.), metals (precious metals such as gold, silver, platinum, palladium and industrial metals such as copper, lead, zinc, tin, aluminum, aluminum alloy, nickel, cobalt, molybdenum, recycled steel, etc.), agricultural products (such as corn, oats, rough rice, soybean, rapeseed, soybean meal, soybean oil, wheat, milk, cocoa, coffee, cotton, sugar, orange juice, etc.), and livestock and meat (such as lean hogs, live cattle, feeder cattle, etc.). Various other products are traded on commodity exchanges such as, for example, rubber, palm oil, wool, polypropylene, and linear low density polyethylene, as well as other products.

A number of commodity pricing indexes may be defined as a cash settlement price based on, for example, a fixed-weight index, an average, or a weighted average of the commodity price, which may be based on spot or future prices. For example, Henry Hub is the price point for natural gas futures contracts traded on the New York Mercantile Exchange (NYMEX) and over-the-counter (OTC) swaps traded on the IntercontinentalExchange (ICE). The pricing index may be based on the Henry Hub price points, for example.

However, with the existing commodity exchanges and commodity pricing indexes, consumers are unable to differentiate between commodities produced by different methods or companies. As a result, commodity producers are driven to produce commodities at the lowest possible cost to meet merely the minimum of safety, health, and environmental regulations or industry standards. Little consumer choice for selecting commodities with improved safety, health, and environmental regulations or industry standards is available with the existing commodity pricing indexes.

### SUMMARY

According to an embodiment, a method for producing a differentiated hydrocarbon commodity is provided, the method comprising: drilling a well according to a first predetermined set of protocols; completing the well according to a second predetermined set of protocols; producing a hydrocarbon commodity from the well according to a third predetermined set of protocols; transporting and distributing the hydrocarbon commodity according to a fourth predetermined set of protocols; identifying the hydrocarbon commodity as the differentiated hydrocarbon commodity based on a compliance level with the protocols.

According to another embodiment, a method for differentiating a commodity is provided, the method comprising: establishing a predetermined set of protocols; establishing a standard for each protocol; collecting data from at least one user device, wherein the at least one user device is configured to send information regarding at least one of the protocols; determining with or by one or more computing devices whether information regarding each of the protocols meets or exceeds an identified protocol compliance threshold; and identifying with or by one or more computing device the commodity as a differentiated commodity when the at least the plurality of the protocols meets or exceeds the identified protocol compliance threshold.

According to another embodiment, a system is provided comprising: a memory; and a processor coupled to the memory, the processor being configured to: collect data from at least one user device regarding a commodity; determine whether information regarding at least a plurality of protocols meets or exceeds an identified protocol compliance threshold; and identify the commodity as a differentiated commodity when the at least the plurality of the protocols meets or exceeds the identified protocol compliance threshold.

According to another embodiment, a computer readable storage medium is provided comprising instructions that if executed enables a computing system to: collect data from at least one user device regarding a commodity; determine whether information regarding at least a plurality of protocols meets or exceeds an identified protocol compliance threshold; and identify the commodity as a differentiated commodity when the at least the plurality of the protocols meets or exceeds the identified protocol compliance threshold.

### BRIEF DESCRIPTION OF THE DRAWINGS

The features and advantages of the invention will be apparent from the following drawings wherein like reference numbers generally indicate identical, functionally similar, and/or structurally similar elements.

FIG. 1 is a flow chart for establishing a commodity price index according to an embodiment;

FIG. 2 is an exemplary embodiment of a set of predetermined protocols in different phases;

FIG. 3 is an exemplary embodiment of a block diagram for a network and system components;

FIG. 4 is a flow chart for establishing a commodity price index for differentiated commodities according to an embodiment; and

FIG. 5 is an exemplary embodiment of a computing device.

### DETAILED DESCRIPTION

Embodiments of the invention are discussed in detail below. In describing embodiments, specific terminology is employed for the sake of clarity. For example, natural gas is used as an exemplary embodiment to describe the methods and systems herein. However, it is foreseen that other commodities, undifferentiated products, goods, and services may be used with the disclosed methods and systems. The invention is not intended to be limited to the specific terminology and commodities so selected and may be configured for other types of commodities and markets or exchanges. A person skilled in the relevant art will recognize that other equivalent parts can be employed and other methods developed without departing from the spirit and scope of the invention.

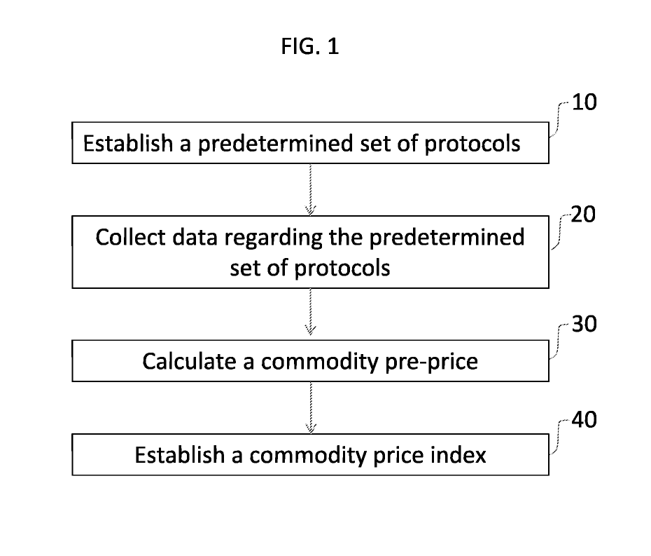

Referring now to FIG. 1, a method for pricing a commodity, such as, for example, natural gas, may generally comprise the steps of 1) establishing a predetermined set of protocols 10, 2) collecting data regarding the predetermined set of protocols 20, 3) calculating a commodity pre-price using an algorithm 30, and 4) establishing a commodity pricing index 40. As explained in more detail below, the methods and systems are directed to differentiating a commodity based on compliance with a set of protocols or the predetermined set of protocols in order to calculate a price for the commodity, such as, for example, a premium price. The order of the steps may be in the order, as described. However, according to an embodiment, the order of the steps is not limited to the order, as described, but may be in any order.

A set of predetermined protocols may be determined in order to achieve a desired consumer product. For example, with natural gas and oil production, the protocols may be targeted to define a hydrocarbon commodity produced with superior standards in safety, health, and/or environment. According to an embodiment relating specifically to environment, the protocols may be desired to define a hydrocarbon commodity having a low environmental impact or carbon footprint.

The phrases “predetermined protocols” or “predetermined set of protocols” may refer to protocols in existence at the time of an activity or phase, such as, for example, when drilling a well is undertaken. As the protocols are designed to collectively define a perceived quality premium over then-existing practices, which will themselves change over time with technology, regulation, and other events, the protocols, such as the predetermined protocols or predetermined set of protocols, may be changed or revised to reflect these changes and ensure that a quality premium continues to be perceived by, for example, the public, industry, or other groups. According to an embodiment, the predetermined protocols or predetermined set of protocols may be periodically or continuously changed or revised over time in order to, for example, maintain a perceived quality differentiation or premium.

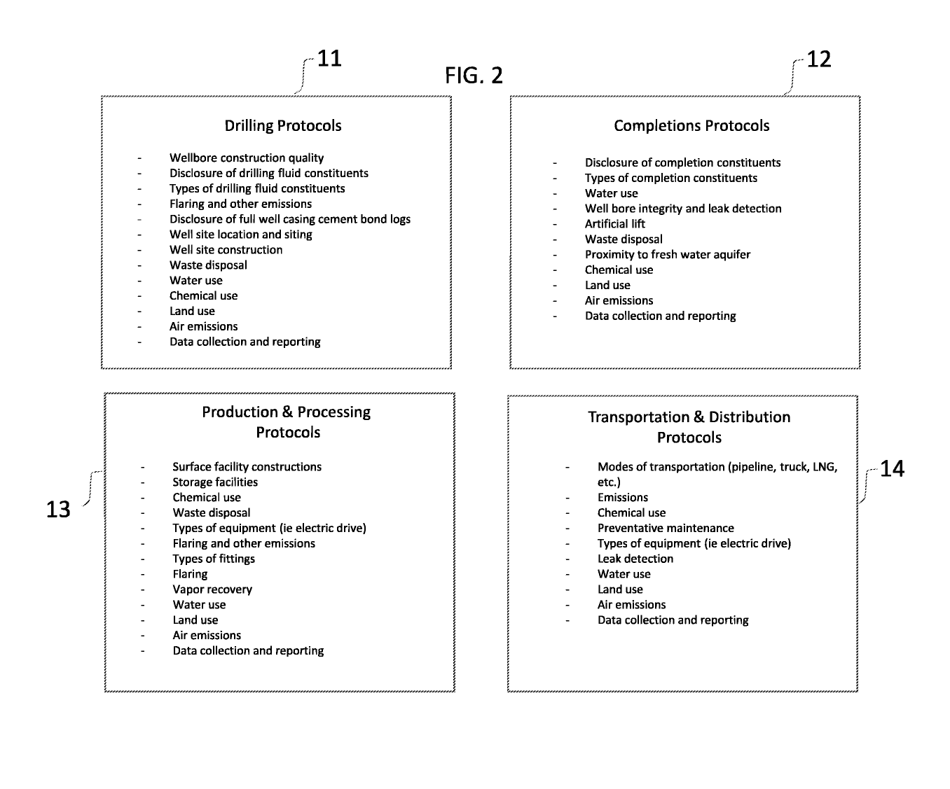

According to an embodiment, the set of predetermined protocols may be divided into categories according to various phases of bringing hydrocarbon products to market or sales. Referring now to FIGS. 2, protocols may be established for all phases of exploration, drilling, completion, production, processing, transportation, and/or distribution of a hydrocarbon product. The predetermined set of protocols may be established, for example, to define a natural gas or hydrocarbon, or other derivative or commodity having decreased emissions and a smaller environmental impact. However, it is foreseen that the protocols may change as new technologies and industry best practices emerge that further lessen the environmental impact of each of the phases. Accordingly, as explained above, the predetermined protocols or set of predetermined protocols may change as technology and industry best practices change and/or as industry or public expectations change regarding, for example, environmental impact, carbon footprint, or other quality.

Regarding wellbore drilling, the set of predetermined protocols 11 may focus on environmentally friendly drilling practices and facilities, construction standards, and wellbore design to minimize the environmental impact during drilling and during later production of the well. For example, the protocols may be any combination of, but not limited to, standards for constructing the drill site, drilling, and testing to avoid and/or identify environmental contamination. The protocols relating to constructing the drill site may include, for example, locating drill sites a predetermined distance from bodies of water and other environmentally sensitive areas, locating drill sites a predetermined distance from homes, building berms around drill site to contain spills, lining the drill site to avoid soil contamination, minimize fugitive air emissions, employing vapor recovery for tank batteries, and minimizing any flaring or venting. The protocols relating to drilling may include, for example, state of the art wellbore construction quality, disclosing of drilling fluid constituents, no venting or flaring, disclosing of full well casing cement bond logs, and utilizing grey water sources. The protocols relating to testing may include, for example, tracking all waste until it reaches an approved disposal facility, conducting water quality tests on nearby bodies of water and aquifers before and periodically after drilling, conducting soil tests before and periodically after drilling, and testing all pipe, valves, and fittings for fugitive emissions. Sensitivity to fresh water zone or aquifer contamination may also require protocols regarding wellbore casing and cementing in close proximity to the freshwater zone such as, for example, cementing and double strings at least 100 feet below the freshwater zone.

Regarding wellbore completions, the set of predetermined protocols 12 may focus on environmentally friendly completions, wellbore construction, wellbore testing and integrity. The protocols relating to completions may be, for example, any combination of, but not limited to, disclosing of completion constituents within a predetermined amount of time (such as, for example, 30 days), using environmentally friendly completion constituents, using grey water sources, and tracking all waste until it reaches an approved disposal facility. The protocols relating to wellbore construction may be, for example, any combination of, but not limited to, disclosing of completion constituents with a predetermined amount of time (such as, for example, 30 days), using environmentally friendly completion constituents, using grey water sources, and tracking all waste until it reaches an approved disposal facility. The protocols relating to wellbore testing and integrity may be, for example, any combination of, but not limited to, performing regular or frequent wellbore integrity tests, testing for wellbore leaking or casing or cementing failure, identifying defective or failing downhole or wellbore integrity and immediately implementing repair or mitigation, testing water quality in nearby bodies of water and aquifers before and periodically after completion.

Regarding production of hydrocarbons, the set of predetermined protocols 13 may focus on environmentally friendly production facility construction, gathering system construction, and emissions. The protocols relating to production facility construction may be, for example, any combination of, but not limited to, utilizing flanged couplings and welded pipe to reduce fugitive emissions, installing vapor recovery units on tank batteries to recover tank vapors, installing electric drive compression and pumping facilities, eliminating or minimizing flare and venting, installing modular or portable equipment for ease of facility abandonment, locating facilities a predetermined distance away from waterways or other environmentally sensitive areas; and utilizing sound or noise mitigation equipment to reduce noise pollution. The protocols relating to gathering system construction may be, for example, any combination of, but not limited to, utilizing flanged couplings and welded pipe to reduce fugitive emissions, maintaining clear right-of-way to regularly monitor gathering system integrity and leaks, maintaining anti-corrosion treatments of the gathering system to avoid leaks, and utilizing electric drive compression or pumps.

Similarly, regarding processing, the set of predetermined protocols may focus on environmentally friendly production facility construction and emissions such as with the protocols regarding production. Additionally, the protocols may include eliminating venting or uncontrolled emission of hydrocarbon production byproducts such as, for example, carbon dioxide (such as from coal bed methane production), salt water, hydrogen sulfide, and other byproducts.

Regarding transportation and distribution of the hydrocarbons, the set of predetermined protocols 14 may focus on environmentally friendly pipeline facility construction or trucking facilities, pipeline construction and maintenance, and emissions. The protocols relating to pipeline facility construction or trucking facilities construction may be, for example, any combination of, but not limited to, utilizing flanged couplings and welded pipe to reduce fugitive emissions, installing vapor recovery units on tank batteries to recover tank vapors, installing electric drive compression and pumping facilities, eliminating or minimizing flare and venting, installing modular or portable equipment for ease of facility abandonment, locating facilities a predetermined distance away from waterways or other environmentally sensitive areas, utilizing sound or noise mitigation equipment to reduce noise pollution, installing vapor capture and recovery devices at trucking facilities, and instituting procedures to minimize vehicle idling and emissions. The protocols relating to pipeline construction and maintenance may be, for example, any combination of, but not limited to, utilizing flanged couplings and welded pipe to reduce fugitive emissions, maintaining clear right-of-way to regularly monitor pipeline integrity and leaks, maintaining anti-corrosion treatments of the gathering system to avoid leaks, performing preventative maintenance and smart pigging to monitor pipeline integrity, and utilizing electric drive compression or pumps.

Other protocols may be, for example, establishing procedures to minimize idling vehicles and vehicle emissions, minimizing land disturbances, establishing training certification programs, establishing safety systems and procedures. Still other protocols may be regarding reporting protocols, such as, for example, but not limited to, reporting all hydraulic fracturing constituents (such as, for example, within 30 days of completion) such as, for example, chemicals and other constituents, reporting all completion constituents such as, for example, chemicals, proppants, and other constituents, reporting tracking for all waste disposal, reporting water use of fresh, grey and recycled water, reporting air, water and sound test results, reporting wellbore and equipment safety test results, reporting a percentage of certified trained personnel used on locations, reporting accidents, and reporting measureables or other information relevant or relating to any of the protocols mentioned above.

In general the predetermined set of protocols may be selected in order to define the hydrocarbon or other commodity having decreased emissions and a smaller environmental impact as compared with hydrocarbons or other commodities produced according to a lower or industry standard. It is foreseen that the predetermined set of protocols may be selected in order to define a commodity according to other desired factors. It is also foreseen that the predetermined protocols or predetermined set of protocols may change as new technologies and industry best practices emerge that further lessen the environmental impact, for example, of each of the phases.

According to an embodiment, a system of automatic and manual collection of data regarding the set of predetermined protocols may be used in combination with the various methods described herein.

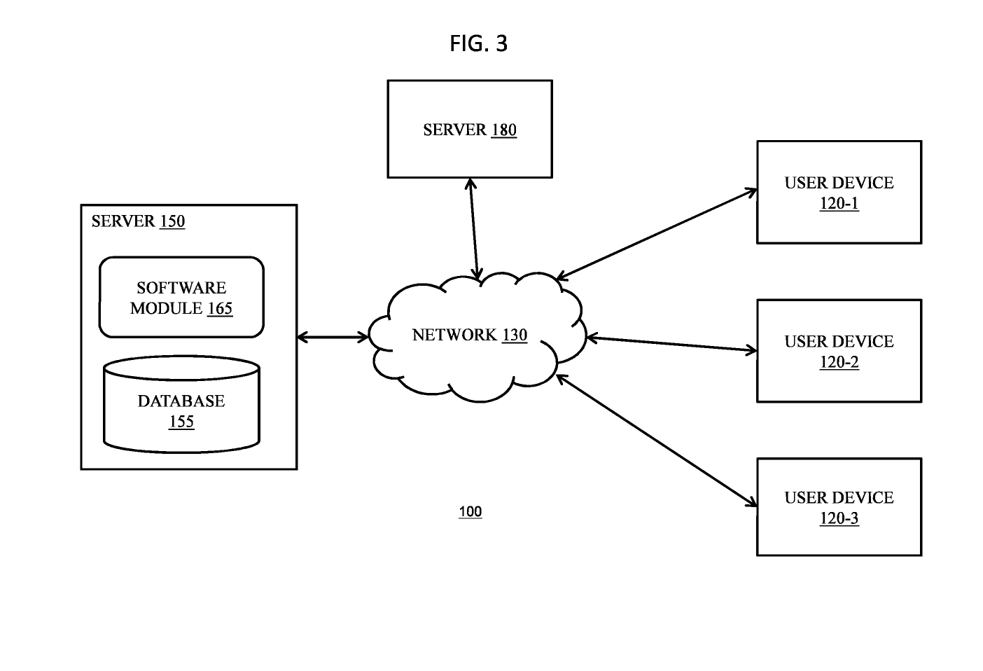

Referring now to FIG. 3, a block diagram of an exemplary system 100 in accordance with one or more embodiments is illustrated. System 100 may include one or more user devices, e.g. user device 120-1, user device 120-2, and user device 120-3, network 130, server 150, database 155, software module 165, and server 180. It is foreseen that any plurality of devices may be used according to various embodiments. For example, the plurality of devices may be a predetermined or identified number of devices.

The one or more user devices, e.g. user device 120-1, user device 120-2, and user device 120-3, may be any type of computing device, including a mobile telephone, a laptop, tablet, or desktop computer having, for example, a processor, a netbook, a video game device, a pager, a smart phone, an ultra-mobile personal computer (UMPC), a personal data assistant (PDA), or a device connected to one or more of a flow meter, pressure sensor, temperature sensor, downhole sensor, methane sensor, or other types of sensing equipment.

The one or more user devices may run one or more applications, such as Internet browsers, voice calls, video games, videoconferencing, and email, among others. The one or more user devices may be any combination of computing devices. These devices may be coupled to network 130 and configured to send and/or receive data to network 130.

According to an embodiment, the user device may be a sensor which may be placed at a particular location to monitor an identified item, protocol, or compliance with a protocol, such as a predetermined protocol for an identified phase. For example, but not limited to, the sensor may be a methane sensor to detect methane or fugitive emissions. It is foreseen, for example, that sensors may be utilized as a user device to detect any of various physical or environmental items or of a detectable or measurable quality or quantity. Other items may be, for example, but not limited to, pressure, temperature, flow sensors, and other types of sensors known to one of ordinary skill in the art.

According to an embodiment, the one or more user devices, e.g. user device 120-1, user device 120-2, and user device 120-3 may be configured to send and/or receive data to network 130 regarding the set of predetermined protocols. For example, regarding the protocols for production facilities, user device 120-1 may be used by a construction foreman to report that all pipes, valves, and fittings are flanged and welded; user device 120-2 may be used by a facility operator to report that new electric drive compressor or pumps have been installed; and user device 120-3 may be used to report a flow meter reading indicating vapor flow to a vent or flare. As explained above, it is foreseen that any number of user devices may be used to report any number of the predetermined set of protocols, either automatically or manually. According to an embodiment, a user device may also be used to access data regarding a particular production facility or operation or any of the phases, for example, from publicly available or government (state or federal) or industry databases. For example, the database may be accessed to retrieve, for example, emissions, spill, or other environmental data, production data, or other health, safety, and environment data. According to an embodiment, the data may be retrieved or input automatically or manually.

According to an embodiment, each of the user devices may be configured to further identify a particular drillwell or wellsite, oil & gas or hydrocarbon lease, gathering system, production facility, pipeline, or other phase of commodity or hydrocarbon production. For example, an identifier may be used to track a source of a commodity through each of any phase from production to market. In such a manner, the identification to a particular aspect may allow an algorithm, as further explained below, to calculate whether the phase alone or all phases collectively meets an identified threshold of compliance with the predetermined set of protocols. According to different embodiments, if the phase alone or all phases collectively meets an identified threshold of compliance with the predetermined set of protocols, then the hydrocarbon or commodity may be a differentiated commodity with a price point at a premium to the underlying and/or undifferentiated hydrocarbon or commodity. According to an embodiment, the identified threshold of compliance may be, for example, but not limited to, compliance with a predetermined or identified number of protocols, predetermined protocols, and/or predetermined set of protocols.

Network 130 may provide network access, data transport and other services to the devices coupled to it in order to send/receive data from any number of user devices, as explained above. In general, network 130 may include and implement any commonly defined network architectures including those defined by standards bodies, such as the Global System for Mobile communication (GSM) Association, the Internet Engineering Task Force (IETF), and the Worldwide Interoperability for Microwave Access (WiMAX) forum. For example, network 130 may implement one or more of a GSM architecture, a General Packet Radio Service (GPRS) architecture, a Universal Mobile Telecommunications System (UMTS) architecture, and an evolution of UMTS referred to as Long Term Evolution (LTE). Network 130 may, again as an alternative or in conjunction with one or more of the above, implement a WiMAX architecture defined by the WiMAX forum. Network 130 may also comprise, for instance, a local area network (LAN), a wide area network (WAN), the Internet, a virtual LAN (VLAN), an enterprise LAN, a layer 3 virtual private network (VPN), an enterprise IP network, or any combination thereof.

Server 150 or server 180 may also be any type of computing device coupled to network 130, including but not limited to a personal computer, a server computer, a series of server computers, a mini computer, and a mainframe computer, or combinations thereof. Server 150 or server 180 may be a web server (or a series of servers) running a network operating system, examples of which may include but are not limited to Microsoft Windows Server, Novell NetWare, or Linux. Server 150 or server 180 may be used for and/or provide cloud and/or network computing. Although not shown in FIG. 3, server 150 and or server 180 may have connections to external systems like email, SMS messaging, text messaging, ad content providers, etc. Any of the features of server 150 may be also implemented in server 180 and vice versa.

Database 155 may be any type of database, including a database managed by a database management system (DBMS). A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Oracle database, IBM DB2, Adaptive Server Enterprise, FileMaker, Microsoft Access, Microsoft SQL Server, MySQL, PostgreSQL, and a NoSQL implementation. A DBMS typically includes a modeling language, data structure, database query language, and transaction mechanism. The modeling language is used to define the schema of each database in the DBMS, according to the database model, which may include a hierarchical model, network model, relational model, object model, or some other applicable known or convenient organization. Data structures can include fields, records, files, objects, and any other applicable known or convenient structures for storing data. A DBMS may also include metadata about the data that is stored.

Software module 165 may be a module that is configured to send, process, and receive information at server 150. Software module 165 may provide another mechanism for sending and receiving data at server 150 besides handling requests through web server functionalities. Software module 165 may send and receive information using any technique for sending and receiving information between processes or devices including but not limited to using a scripting language, a remote procedure call, an email, a tweet, an application programming interface, Simple Object Access Protocol (SOAP) methods, Common Object Request Broker Architecture (CORBA), HTTP (Hypertext Transfer Protocol), REST (Representational State Transfer), any interface for software components to communicate with each other, using any other known technique for sending information from a one device to another, or any combination thereof.

Although software module 165 may be described in relation to server 150, software module 165 may reside on any other device. Further, the functionality of software module 165 may be duplicated on, distributed across, and/or performed by one or more other devices, either in whole or in part.

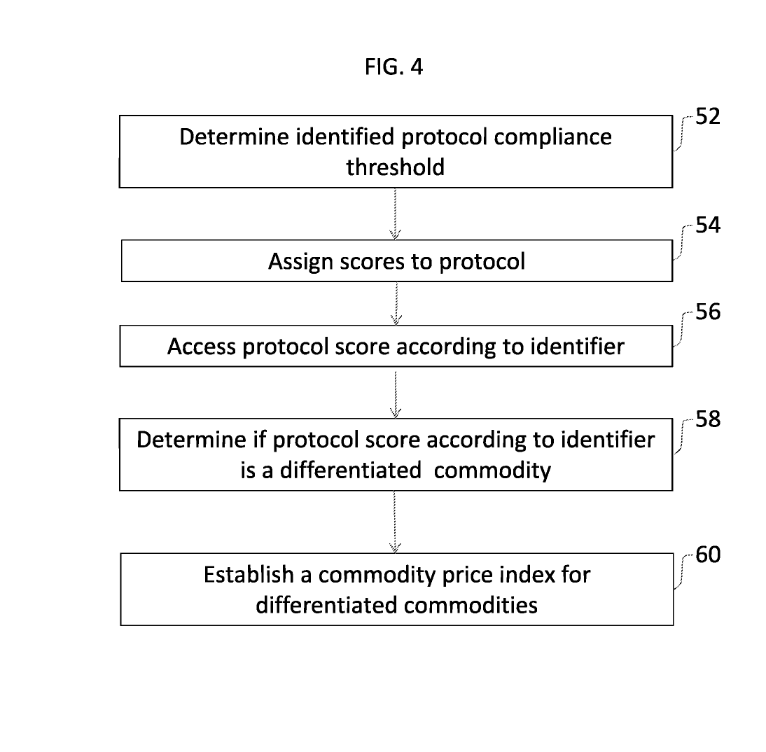

Referring now to FIGS. 3 and 4, according to an embodiment, the results of the data collection may be compiled into the database 155 to determine whether the hydrocarbon or commodity meets an identified threshold of compliance with the predetermined set of protocols. As shown at FIG. 4, the software 165 may be programmed or configured to perform the steps of 1) determining the identified protocol compliance threshold 52, 2) assigning scores to each protocol 54, such as, for example, in response to retrieved or collected data, 3) accessing the protocol score according to an identifier 56, 4) determining if the protocol score according to the identifier is a differentiated commodity 58, and, 5) establishing a commodity price index for differentiated commodities 60. The order of steps may be in the order, as described. However, according to an embodiment, the order of steps may be in any order.

The software 165 may be programmed or configured with an identified protocol compliance threshold. For example, the identified protocol compliance threshold may be, for example, a quantitative threshold or a qualitative threshold. For a quantitative threshold, the identified protocol compliance threshold may be a number such as, for example, an integer. For a qualitative threshold, the identified protocol compliance threshold may be determined by assessing compliance with the protocols. According to an embodiment, the identified protocol compliance threshold may be a minimum protocol compliance threshold. For example, with a quantitative threshold, the minimum protocol compliance threshold may be an identified quantity or number.

The software 165 may be configured to determine whether each of the predetermined protocols reported by the user-device is satisfied. For the qualitative threshold, if the reported protocol satisfies a standard for the protocol, then a score may be assigned to the protocol, such as, for example, a positive score. If the reported protocol does not satisfy the standard, then the assigned score may be, for example, zero or a negative number or integer. Similarly, if a protocol is not reported, then the assigned score may be, for example, zero or a negative number or integer. According to an embodiment, the scores may be weighted depending on the perceived importance of satisfying any particular protocol. According to an embodiment, it is foreseen that standard at which a protocol may satisfy may periodically or continuously change. For example, the standard may become more stringent, less stringent, higher, lower, or otherwise change over time depending on, for example, public awareness, industry best practices, demand, or other criteria. The standard may change, for example, for at least one protocol, a plurality of protocols, all of the protocols, or none of the protocols.

The software 165 may be configured to access the protocol and/or protocol scores from the database 155 having a single identifier or a desired group of identifiers assigned to each protocol and/or protocol score. The single identifier or group of identifiers may indicate, for example, but not limited to, a common source, such as a well, a common lease, such as a group of wellbore, a common region, such as production from a defined geographic area, or a common company.

After accessing the protocol and/or protocol score, the software 165 may be further configured to sum the scores according to the single identifier or group of identifiers and compare the sum of scores with an identified protocol compliance threshold score. If the identified protocol compliance threshold score is achieved or surpassed, the identifier is further indicated as a differentiated hydrocarbon or commodity.

The software 165 may be configured to determine the differentiated hydrocarbon or commodity, as explained above, for only one phase, a plurality of phases less than all of the phases, an identified number of phases, or all of the phases. For example, the software 165 may assign an identified protocol compliance threshold score for only the Drilling Protocols and assess whether a hydrocarbon or commodity according to an identifier meets or exceeds the identified protocol compliance threshold score for Drilling Protocols. If the identified protocol compliance threshold score for Drilling Protocols is achieved or surpassed, the identifier may be further indicated as a differentiated hydrocarbon or commodity.

According to another embodiment, the software 165 may be configured to determine the differentiated hydrocarbon or commodity, as explained above, for all of the phases. As explained with respect to the Drilling Protocols, the Completions Protocols, Production & Processing Protocols, and Transportation & Distribution Protocols may be similarly assessed for whether a hydrocarbon or commodity according to an identifier meets or exceeds the identified protocol compliance threshold score for the sum of the phases of all the protocols. If the identified protocol compliance threshold score for the sum of the phases of protocols is achieved or surpassed by the protocol compliance score, the identifier may be further indicated as a differentiated hydrocarbon or commodity.

According to another embodiment, certain phases may have a common operator such as, for example, a gas plant, refinery, or pipeline. For example, a commodity producer or owner may desire to retain ownership of the hydrocarbon or commodity but utilize a third-party asset such as to transport the hydrocarbon or commodity via third-party pipelines or process via third-party gas plants or refineries, for example. The common operator facilities or operations may be assessed for a protocol compliance score. The protocol compliance score for the third-party asset may be based on data collection from the third-party with respect to the predetermined set of protocols relevant to the particular third-party operations. In order to calculate whether a hydrocarbon or commodity according to an identifier meets or exceeds the identified protocol compliance threshold score, the protocol compliance score from the third party asset may be added to the other protocol compliance scores of the hydrocarbon or commodity having a particular identifier. According to an embodiment, the hydrocarbon or commodity may be assigned more than one or a plurality of identifiers depending on how many third party assets are utilized in the various phases. According to another embodiment, the third party asset may be assigned one or a plurality of identifiers. The plurality of identifiers may be an identifier for the third party asset and the identifier for each hydrocarbon or commodity transported or processed through or with the third party asset, for example. According to an embodiment, for example, the plurality of identifiers may be a predetermined or identified number of identifiers.

Alternatively, where custody of the hydrocarbon or commodity is transferred, such as, for example, through a sales meter, the hydrocarbon or commodity protocol compliance score may be assessed at each transfer of custody.

In such an embodiment, the protocol compliance score through each phase may be summed to determine whether the protocol compliance score meets the identified threshold of compliance with the predetermined set of protocols. According to an embodiment, the protocol compliance score for a hydrocarbon, for example, may be summed through all phases regardless of custody transfer.

The software 165 may be further configured to determine a pre-price for the differentiated hydrocarbons or commodities. For example, another algorithm may determine the pre-price for the hydrocarbon or commodity. The pre-price may be, for example, an additive amount to a spot or futures price traded on a commodities exchange. For example, the pre-price may be an additive value to a spot or futures price set at Henry Hub in $/mmbtu (millions of British thermal units).

The software 165 may be further configured to determine a commodity pricing index. For example, another algorithm may determine a fixed-weight index or an average of selected hydrocarbon or commodity prices based on the pre-price added to the spot or futures prices explained above.

According to an embodiment, the differentiated commodity pricing index or pre-price may be used in combination with a commodity or futures market to sell the differentiated commodity at spot or futures price and/or according to the pricing index. For example, contracts may be settled against the index price on a trading exchange or platform.

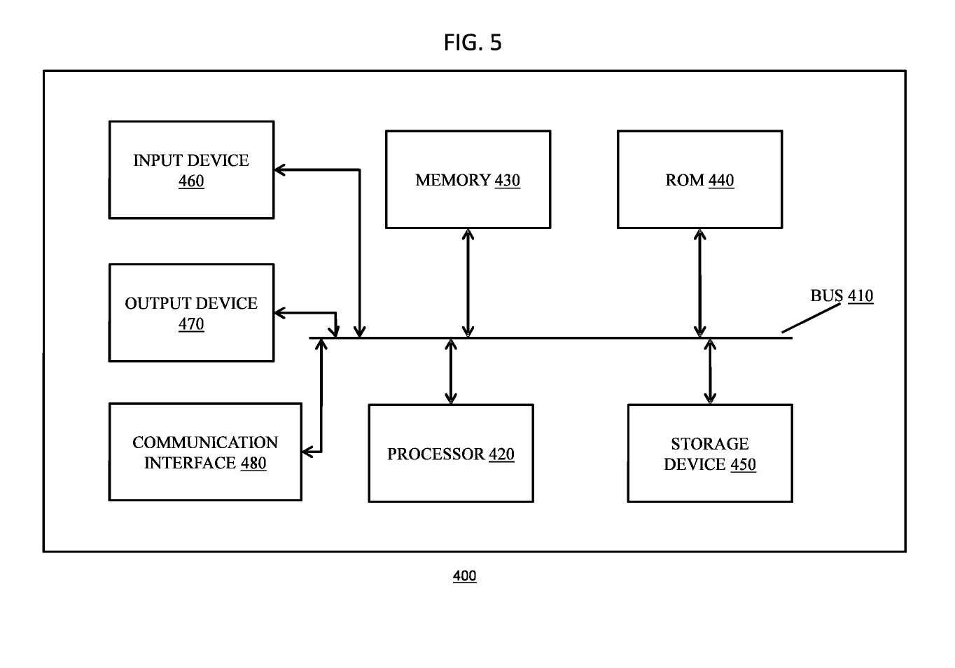

FIG. 5 depicts an exemplary architecture for implementing a computing device 400 in accordance with one or more embodiments, which may be used to implement any of the computing devices discussed herein, or any other computer system or computing device component thereof. It will be appreciated that other devices that can be used with the computing device 400, such as a client or a server, may be similarly configured. As illustrated in FIG. 5, computing device 400 may include a bus 410, a processor 420, a memory 430, a read only memory (ROM) 440, a storage device 450, an input device 460, an output device 470, and a communication interface 480.

Bus 410 may include one or more interconnects that permit communication among the components of computing device 400. Processor 420 may include any type of processor, microprocessor, or processing logic that may interpret and execute instructions (e.g., a field programmable gate array (FPGA)). Processor 420 may include a single device (e.g., a single core) and/or a group of devices (e.g., multi-core). Memory 430 may include a random access memory (RAM) or another type of dynamic storage device that may store information and instructions for execution by processor 420. Memory 430 may also be used to store temporary variables or other intermediate information during execution of instructions by processor 420.

ROM 440 may include a ROM device and/or another type of static storage device that may store static information and instructions for processor 420. Storage device 450 may include a magnetic disk and/or optical disk and its corresponding drive for storing information and/or instructions. Storage device 450 may include a single storage device or multiple storage devices, such as multiple storage devices operating in parallel. Moreover, storage device 450 may reside locally on the computing device 400 and/or may be remote with respect to a server and connected thereto via network and/or another type of connection, such as a dedicated link or channel.

Input device 460 may include any mechanism or combination of mechanisms that permit an operator to input information to computing device 400, such as a keyboard, a mouse, a touch sensitive display device, a microphone, a pen-based pointing device, and/or a biometric input device, such as a voice recognition device and/or a finger print scanning device. Output device 470 may include any mechanism or combination of mechanisms that outputs information to the operator, including a display, a printer, a speaker, etc.

Communication interface 480 may include any transceiver-like mechanism that enables computing device 400 to communicate with other devices and/or systems, such as a client, a server, a license manager, a vendor, etc. For example, communication interface 480 may include one or more interfaces, such as a first interface coupled to a network and/or a second interface coupled to a license manager. Alternatively, communication interface 480 may include other mechanisms (e.g., a wireless interface) for communicating via a network, such as a wireless network. In one implementation, communication interface 480 may include logic to send code to a destination device, such as a target device that can include general purpose hardware (e.g., a personal computer form factor), dedicated hardware (e.g., a digital signal processing (DSP) device adapted to execute a compiled version of a model or a part of a model), etc.

Computing device 400 may perform certain functions in response to processor 420 executing software instructions contained in a computer-readable medium, such as memory 430. In alternative embodiments, hardwired circuitry may be used in place of or in combination with software instructions to implement features consistent with principles of the disclosure. Thus, implementations consistent with principles of the disclosure are not limited to any specific combination of hardware circuitry and software.

Exemplary embodiments may be embodied in many different ways as a software component. For example, it may be a stand-alone software package, a combination of software packages, or it may be a software package incorporated as a “tool” in a larger software product. It may be downloadable from a network, for example, a website, as a stand-alone product or as an add-in package for installation in an existing software application. It may also be available as a client-server software application, or as a web-enabled software application. It may also be embodied as a software package installed on a hardware device.

The methods and systems explained above may define a differentiated commodity based on compliance with predetermined protocols. The predetermined protocols may identify the differentiated commodity based on environmental factors in order to market an environmentally friendly or low impact commodity. However, it is foreseen that the commodity may be differentiated according to other factors which may be more narrow or broad, such as, for example, minimized water use, fair labor and wage practices, minimized emissions, and other factors. As explained above, it is foreseen that any type of commodity or product may be used with the various methods and methods to define a differentiated commodity or product.

Numerous specific details have been set forth to provide a thorough understanding of the embodiments. It will be understood, however, that the embodiments may be practiced without these specific details. In other instances, well-known operations, components and circuits have not been described in detail so as not to obscure the embodiments. It can be appreciated that the specific structural and functional details are representative and do not necessarily limit the scope of the embodiments.

It is worthy to note that any reference to “one embodiment” or “an embodiment” means that a particular feature, structure, or characteristic described in connection with the embodiment is included in at least one embodiment. The appearances of the phrase “in one embodiment” in the specification are not necessarily all referring to the same embodiment.

Although some embodiments may be illustrated and described as comprising exemplary functional components or modules performing various operations, it can be appreciated that such components or modules may be implemented by one or more hardware components, software components, and/or combination thereof. The functional components and/or modules may be implemented, for example, by logic (e.g., instructions, data, and/or code) to be executed by a logic device (e.g., processor). Such logic may be stored internally or externally to a logic device on one or more types of computer-readable storage media.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of storage media include hard drives, disk drives, solid state drives, and any other tangible storage media.

It also is to be appreciated that the described embodiments illustrate exemplary implementations, and that the functional components and/or modules may be implemented in various other ways which are consistent with the described embodiments. Furthermore, the operations performed by such components or modules may be combined and/or separated for a given implementation and may be performed by a greater number or fewer number of components or modules.

Some of the figures may include a flow diagram. Although such figures may include a particular logic flow, it can be appreciated that the logic flow merely provides an exemplary implementation of the general functionality.

Further, the logic flow does not necessarily have to be executed in the order presented unless otherwise indicated. In addition, the logic flow may be implemented by a hardware element, a software element executed by a processor, or any combination thereof.

While various exemplary embodiments have been described above, it should be understood that they have been presented by way of example only, and not limitation. Thus, the breadth and scope of the present disclosure should not be limited by any of the above-described exemplary embodiments.

I claim:

1. A method for producing a differentiated hydrocarbon commodity, the method comprising:
drilling a well according to a first predetermined set of protocols;
completing the well according to a second predetermined set of protocols;
producing a hydrocarbon commodity from the well according to a third predetermined set of protocols;
transporting and distributing the hydrocarbon commodity according to a fourth predetermined set of protocols;
identifying the hydrocarbon commodity as the differentiated hydrocarbon commodity based on a compliance level with the protocols.

2. The method of claim 1, wherein the first predetermined set of protocols is at least one of locating a drill site a predetermined distance from bodies of water, locating drill sites a predetermined distance from homes, building berms around a drill site to contain spills, lining the drill site to avoid soil contamination, minimizing fugitive air emissions, employing vapor recovery for tank batteries, minimizing any flaring and/or venting, wellbore construction quality, disclosing of drilling fluid constituents, eliminating venting or flaring, disclosing of full well casing cement bond logs, utilizing grey water sources, tracking waste, conducting water quality tests on bodies of water and aquifers before and periodically after drilling, conducting soil tests before and periodically after drilling, and testing pipe, valves, and fittings for fugitive emissions.

3. The method of claim 1, wherein the second predetermined set of protocols is at least one of disclosing of completion constituents within a predetermined amount of time after completion, using predetermined completion constituents, using grey water sources, tracking waste, performing wellbore integrity tests, testing for wellbore leaking or casing or cementing failure, identifying defective or failing downhole or wellbore integrity, implementing repair or mitigation on defective or failed wellbores, testing water quality in bodies of water and aquifers before and periodically after completion.

4. The method of claim 1, wherein the third predetermined set of protocols is at least one of utilizing flanged couplings and welded pipe to reduce fugitive emissions, installing vapor recovery units on tank batteries to recover tank vapors, installing electric drive compression and pumping facilities, eliminating flaring and/or venting, installing modular or portable equipment for ease of facility abandonment, locating facilities a predetermined distance away from waterways or other environmentally sensitive areas; and utilizing sound or noise mitigation equipment to reduce noise pollution, maintaining clear right-of-way, monitoring gathering system integrity and leaks, and maintaining anti-corrosion treatments of the gathering system to avoid leaks.

5. The method of claim 1, wherein the fourth predetermined set of protocols is at least one utilizing flanged couplings and welded pipe to reduce fugitive emissions, installing vapor recovery units on tank batteries to recover tank vapors, installing electric drive compression and pumping facilities, eliminating or minimizing flaring and/or venting, installing modular or portable equipment for ease of facility abandonment, locating facilities a predetermined distance away from waterways, utilizing sound or noise mitigation equipment to reduce noise pollution, installing vapor capture and recovery devices at trucking facilities, instituting procedures to minimize vehicle idling and emissions, maintaining clear right-of-way, monitoring pipeline integrity and leaks, maintaining anti-corrosion treatments of the gathering system to avoid leaks, performing preventative maintenance, and smart pigging to monitor pipeline integrity.

6. The method of claim 1, further comprising changing at least one of the first predetermined set of protocols, the second predetermined set of protocols, the third predetermined set of protocols, and the fourth predetermined set of protocols.

7. A method for differentiating a commodity, the method comprising:
establishing a predetermined set of protocols;
establishing a standard for each protocol;
collecting data from at least one user device, wherein the at least one user device is configured to send information regarding at least one of the protocols;
determining by one or more computing devices whether information regarding each of the protocols meets or exceeds an identified protocol compliance threshold; and
identifying the commodity as a differentiated commodity when the at least the plurality of the protocols meets or exceeds the identified protocol compliance threshold.

8. The method of claim 7, wherein the at least one user device is any network connected device.

9. The method of claim 7, the method further comprising:
assigning a unique identifier to the commodity to be differentiated.

10. The method of claim 9, wherein the unique identifier identifies a source of the commodity.

11. The method of claim 10, the method further comprising assigning different unique identifiers to different sources of the commodity; and
determining by the one or more computing devices whether information regarding each of the protocols for each of the unique identifiers meets or exceeds the identified protocol compliance threshold.

12. The method of claim 7, the method further comprising:
establishing the identified protocol compliance threshold;
assigning a score to the information regarding the protocols;
determining the score by the computing device;
wherein in the determining by the one or more computing devices whether information regarding each of the protocols meets or exceeds an identified protocol compliance threshold, comparing the score to the identified protocol compliance threshold.

13. The method of claim 7, the method further comprising:
determining with the one or more computing devices a pre-price for the differentiated commodity.

14. The method of claim 13, the method further comprising:
adding the pre-price to a commodity market price.

15. The method of claim 14 the method further comprising:
settling a contract based on the pre-price added to the commodity market price.

16. The method of claim 7, wherein the collecting data with the one or more computing devices from at least one user device further comprises:
collecting data manually entered into the user device.

17. The method of claim 16, wherein the user device is a wireless device, a cellular device, or a mobile device.

18. The method of claim 7, wherein the collecting data with the one or more computing devices from at least one user device further comprises:
collecting data automatically computed by, sensed by, or entered into the user device.

19. The method of claim 18, wherein the user device is a sensor.

20. The method of claim 18, wherein the user device is a database.

21. The method of claim 9, the method further comprising:
establishing the predetermined set of protocols for each of a plurality of phases.

22. The method of claim 21, wherein each of the plurality of phases corresponds to different aspects of the commodity.

23. The method of claim 22, wherein determining by one or more computing devices whether information regarding each of the protocols meets or exceeds an identified protocol compliance threshold further comprises:
establishing an identified protocol compliance threshold for only one phase;
determining by the one or more computing devices whether information regarding at least the plurality of protocols for the only one phase meets or exceeds the identified protocol compliance threshold for the only one phase.

24. The method of claim 22, wherein determining by one or more computing devices whether information regarding each of the protocols meets or exceeds an identified protocol compliance threshold further comprises:
establishing an identified protocol compliance threshold for a plurality of phases;
determining by the one or more computing device whether information regarding at least the plurality of protocols for the plurality of phases meets or exceeds the identified protocol compliance threshold for the plurality of phases.

25. The method of claim 24, wherein the plurality of phases is all of the phases.

26. The method of claim 7, further comprising changing the predetermined set of protocols.

27. The method of claim 7, further comprising changing the standard for at least one protocol.

28. A system comprising:
a memory; and
a processor coupled to the memory, the processor being configured to:
collect data from at least one user device regarding a commodity;
determine whether information regarding at least a plurality of protocols meets or exceeds an identified protocol compliance threshold; and
identify the commodity as a differentiated commodity when the at least the plurality of the protocols meets or exceeds the identified protocol compliance threshold.

29. A computer readable storage medium comprising instructions that if executed enables a computing system to:
collect data from at least one user device regarding a commodity;
determine whether information regarding at least a plurality of protocols meets or exceeds an identified protocol compliance threshold; and
identify the commodity as a differentiated commodity when the at least the plurality of the protocols meets or exceeds the identified protocol compliance threshold.
